(19) United States
(12) Patent Application Publication
(10) Pub. No.: US 2024/0000644 A1
(43) Pub. Date: Jan. 4, 2024

(54) AIR MAT FOR PREVENTING BEDSORE

(71) Applicant: Hyunseung HEO, Asan-si, Chungcheongnam-do (KR)

(72) Inventor: Hyunseung HEO, Asan-si, Chungcheongnam-do (KR)

(21) Appl. No.: 18/039,290

(22) PCT Filed: Oct. 27, 2021
(86) PCT No.: PCT/KR2021/015173

§ 371 Date: May 30, 2023

(30) Foreign Application Priority Data
Jan. 4, 2021 (KR) 10-2021-0000103

(51) Int. Cl. A61G 7/057

(52) U.S. Cl. CPC A61G 7/05776; A61G 2203/10; A61G 2200/32

(57) ABSTRACT

An air mat for preventing bedsores includes a cushion part 100 in which at least two or more cell members 110a to 110d are disposed in a row direction, and each of the cell members 110a to 110d has an independent inner space, and is connected with ducts 120a to 120d for supplying air pressure for each cell member to receive air pressure independently, so that expansion and contraction can be performed, a frame member 200 provided with a storage space having an open top surface, a bottom surface and side surfaces surrounding the bottom surface, and a control part 300 that controls the opening/closing time of air input/output valves by an electronic control method by setting target air pressure by time for each of the cell member 110a to 110d of the cushion part 100 to control the cell members 110a to 110d, respectively.

### TECHNICAL FIELD

The present invention relates to an air mat for preventing a bedsore, and particularly, to an air mat for preventing a bedsore, which changes the position of the patient lying on the mat for a long time to prevent the bedsore by dividing the mats in contact with the patient's body and separately controlling the air pressure of each mat.

### BACKGROUND ART

In general, patients who lie in bed for a long time due to mobility difficulties or paralyzed patients such as paraplegia and general paralysis are prone to get a bedsore in the area under pressure due to poor blood circulation and metabolism due to the prolonged posture.

When the bedsore occur, the bedsore causes serious effects and complications on the skin tissue, which can cause more pain in the patient.

In order to prevent the bedsore, it is necessary to change the patient's lying position every certain time to relieve the burden on the pressure area. To this end, the caregiver should allow the patient to lie on his side facing the left or right side every certain time to relieve the pressure burden on the back and buttocks, where the bedsore usually occurs while the patient is lying down, and change the patient's body posture from time to time.

However, it is a task that requires a lot of strength for the caregiver to change the patient's physical position from time to time, which can be very burdensome and hassle-consuming for the caregiver.

In order to solve this problem, an air mat having an air cell that is floated alternately has been invented. The air mat is a scheme in which air or gel is injected into the patient's mattress to reduce the contact body pressure between the human body and the mattress to a body pressure below the occurrence of the bedsore, and the caregiver adjusts the air (air) pressure of the mattress so that the body pressure can be distributed below 32 mmHg, which is the starting pressure of clinically known bedsore occurrence to prevent the bedsore.

However, due to the large size of the air cells constituting the air mat, the area in contact with the patient is relatively small, so there is a problem that the patient's weight cannot be properly distributed. Therefore, the load is concentrated on a part of the patient's body, which increases the possibility of the bedsore along with discomfort in use.

In addition, in the case of the air mat, since the mattress has a static fluid form, it is possible to reduce the overall average body pressure of the body, but there is a problem that it is impossible to adjust the air pressure according to each part of the body. Therefore, since it is impossible to remove the high pressure or pressure on a specific region due to the weight and contact area of each part of the body caused by biomechanical differences, there is a problem that the bedsore occurs locally in parts of the body that have body pressure that exceeds the occurrence of the bedsore.

Therefore, in recent years, a technique for controlling the pressure on the individual air bags constituting the mattress has been proposed in order to eliminate the pressure beyond the occurrence of a local bedsore, but this individual control method is difficult to put into practical use due to the complexity of the configuration of the device for controlling the pressure on dozens of air pockets and the high cost of constructing such a device.

### DISCLOSURE

### Technical Problem

The present invention is contrived to solve the problem, and an object of the present invention is to provide an air mat for preventing a bedsore, which changes the position of the patient lying on the mat for a long time to prevent the bedsore by dividing the mats in contact with the patient's body and separately controlling the air pressure of each mat.

Another object of the present invention is to provide an air mat for preventing a bedsore, which can prevent manpower from being wasted by periodically changing the patient's position by a separate caregiver in order to prevent the bedsore.

Yet another object of the present invention is to provide an air mat for preventing a bedsore, in which after combining the air mat into the left and right sides in a divided manner, the injection and discharge of air are carried out with a time difference, so that the left and right air mats can be expanded and contracted sequentially, and the patient's position can be changed and laid down without the assistance of a guardian.

The objects of the present invention are not limited to the above-mentioned objects, and other objects and advantages of the present invention that are not mentioned can be understood by the following description, and will be more clearly understood by embodiments of the present invention. Further, it will be readily appreciated that the objects and advantages of the present invention can be realized by means and combinations shown in the claims.

### Technical Solution

In order to achieve the object, according to the present invention, there is provided an air mat for preventing bedsores including a cushion part 100 in which at least two or more cell members 110a to 110d are disposed in a row direction, and each of the cell members 110a to 110d has an independent inner space, and is connected with ducts 120a to 120d for supplying air pressure for each cell member to receive air pressure independently, so that expansion and contraction can be performed, a frame member 200 provided with a storage space having an open top surface, a bottom surface and side surfaces surrounding the bottom surface, and a control part 300 that controls the opening/closing time of air input/output valves by an electronic control method by setting target air pressure by time for each of the cell member 110a to 110d of the cushion part 100 to control the cell members 110a to 110d, respectively, In which at least two of the cell members 110a to 110d sequentially may expand and contract from left to right or from right to left with a certain time difference.

Preferably, the cushion part 100 may include cell members 110a to 110d which have independent inner spaces, have at least two or more of which are arranged in a row direction, and expand and contract sequentially in one directions A and B with a certain time difference by pneumatic pressure, a locking plate 140 provided to have a constant height and closely positioned to the outer surfaces of the outermost cell members 110a and 110d among the cell members 110a to 110d to prevent a patient from falling, and at least one air hole 150 for spraying air introduced through ducts 120a to 120d to the upper surfaces of the cell members 110a to 110d.

Preferably, the control part 300 may include an air generator 310 for supplying air pressure to the plurality of ducts 120a to 120d, a direction controller 320 including a solenoid valve and switching the direction in which air pressure is provided to the plurality of ducts 120a to 120d by a control signal, and a controller that generates a control signal for controlling air pressure to be sequentially supplied to the plurality of ducts 120a to 120d from left to right or from right to left with a certain time difference.

### Advantageous Effects

The air mat for preventing the bedsore according to the present invention described as above has the following effects.

First, by dividing the mats in contact with the patient's body and separately controlling the air pressure of each mat, it is possible to change the position of the patient lying on the mat for a long time to prevent the bedsore.

Second, in order to prevent the bedsore, it is possible to prevent manpower from being wasted by periodically changing the patient's position by a separate caregiver.

Third, after combining the air mat into the left and right sides in a divided manner, the injection and discharge of air are carried out with a time difference, so that the left and right air mats can be expanded and contracted sequentially, and the patient's position can be changed and laid down without the assistance of a guardian.

In addition to the above-described effects, the specific effects of the present invention are described together while describing specific matters for implementing the invention below.

### DESCRIPTION OF DRAWINGS

FIG. 1 is a configuration diagram illustrating a configuration of an air mat for preventing bedsores according to an embodiment of the present invention.

FIG. 2 is a configuration diagram illustrating a configuration of a cushion part of FIG. 1 in detail.

FIG. 3 is a configuration diagram for describing an operation of the air mat for preventing bedsores according to the present invention.

### MODE FOR INVENTION

Other objects, characteristics and advantages of the present invention will be apparent through a detailed description of the embodiments with reference to the accompanying drawings.

Terms used in the present invention adopt general terms which are currently widely used as possible by considering functions in the present invention, but the terms may be changed depending on an intention of those skilled in the art, a precedent, emergence of new technology, etc. Further, in a specific case, a term which an applicant arbitrarily selects is present and in this case, a meaning of the term will be disclosed in detail in a corresponding description part of the invention. Accordingly, a term used in the present invention should be defined based on not just a name of the term but a meaning of the term and contents throughout the present invention.

A preferred embodiment of an air mat for preventing a bedsore according to the present invention will be described below with reference to the accompanying drawings. However, the present invention is not limited to an embodiment disclosed below but may be implemented in various different shapes and the present embodiment just completes a disclosure of the present invention and is provided to completely inform a scope of the present invention to those skilled in the art. Accordingly, configurations illustrated in the exemplary embodiments and drawings disclosed in the present specification are only the most preferred embodiment of the present invention and do not represent all of the technical spirit of the present invention, and thus it is to be understood that various equivalents and modified examples, which may replace the configurations, are possible when filing the present application.

Hereinafter, any component is placed on the “top (or bottom)” of the component or the “top (or bottom)” of the component may mean that not only that any configuration is placed in contact with the top surface (or bottom) of the component, but also that another component may be interposed between the component and any component disposed on (or under) the component.

Further, when it is disclosed that any component is “connected”, “coupled”, or “linked” to other components, it should be understood that the components may be directly connected or linked to each other, but another component may be “interposed” between the respective components, or the respective components may be “connected”, “coupled”, or “linked” through another component.

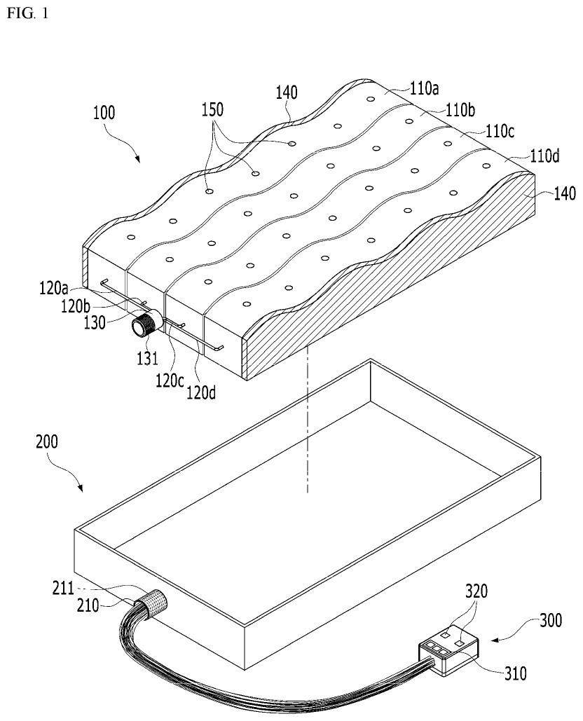

FIG. 1 is a configuration diagram illustrating a configuration of an air mat for preventing bedsores according to an embodiment of the present invention. The air mat for preventing bedsores illustrated in FIG. 1 follows an embodiment, and components thereof are illustrated to the embodiment illustrated in FIG. 1 and if necessary, some components may be added, modified, or deleted.

As shown in FIG. 1, an air mat for preventing bedsores according to the present invention may include a cushion part 100, a frame member 200, and a control part 300.

In the cushion part 100, at least two or more cell members 110a to 110d may be disposed in a row direction. At this time, the row direction refers to a parallel direction when a patient is lying down.

In addition, each of the cell members 110a to 110d has an independent inner space, and is connected with ducts 120a to 120d for supplying air pressure for each cell member to receive air pressure independently, so that expansion and contraction can be performed. In addition, the upper surface of each of the cell members 110a to 110d may be formed in a soft embossed shape with good cushioning.

At this time, the plurality of ducts 120a to 120d may be stored in a coupling end portion 130 which is connected to one side of the cell members 110a to 110d by at least one duct and provided in a cylindrical shape. A locking protrusion 131 may be provided on an upper outer circumferential surface of the coupling end portion 130.

The coupling end portion 130 is stored in a seating end portion 210 provided on the frame member 200, and the locking protrusion 131 may engage with a locking portion 211 provided on an inner circumferential surface of the seating end portion 210.

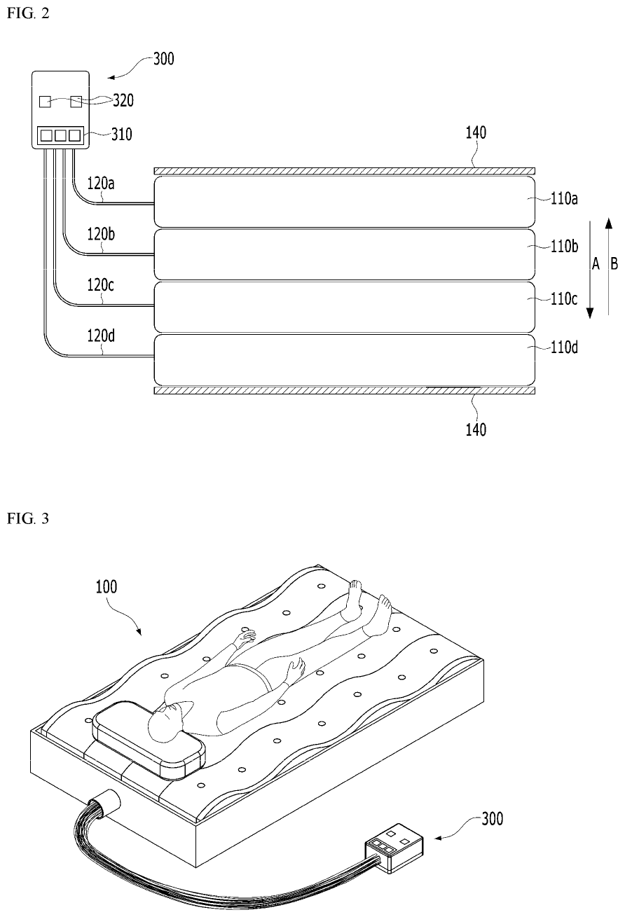

FIG. 2 is a configuration diagram illustrating a configuration of the cushion part of FIG. 1 in detail.

As illustrated in FIGS. 1 and 2, the cushion part 100 may include cell members 110a to 110d which have independent inner spaces, have at least two or more of which are arranged in a row direction, and expand and contract sequentially in one directions A and B with a certain time difference by pneumatic pressure, a locking plate 140 provided to have a constant height and closely positioned to the outer surfaces of the cell members 110a and 110d disposed on the outmost among the cell members 110a to 110d to prevent a patient from falling, and at least one air hole 150 for spraying air introduced through ducts 120a to 120d to the upper surfaces of the cell members 110a to 110d.

All or part of the cell members 110a to 110d may be made of a polymer material such as rubber, silicone, thermoplastic elastomer, thermoplastic polyurethane (TPU), plastic, and the like. In addition, the cell members 110a to 110d may be made of an antimicrobial material itself, or contain the antimicrobial material therein or may be coated with the antimicrobial material on the surface thereof. The antimicrobial material may include any one or at least one of an inorganic antimicrobial agent using, for example, a metal such as copper, silver, zirconium, zinc, or gold, a compound of the metal and other elements, or a material in which the metal is adsorbed or bound to a carrier such as zeolite or glass; an organic antimicrobial agent and a natural antimicrobial agent.

For reference, when the cell members 110a to 110d are injection-molding products of polymer materials, as an example, the antibacterial material may be contained in the cell members 110a to 110d by adding and mixing the antibacterial material to a synthetic resin when mixing a molding material before melting, and as another example, the cell members 110a to 110d are molded with the injection-molding products of polymer materials and then the antibacterial material may be coated on the outer surfaces of the cell members 110a to 110d.

At this time, each of the cell members 110a to 110d is configured so that an embossed portion constituting the upper surface thereof is maintained as it is even in a contracted state as well as in an expanded state, installed apart from the adjacent cell members to expand and contract independently, and expands and contracts sequentially from the left to the right or from the right to the left with a certain time difference.

The sequential expansion and contraction may allow a position of the patient to be smoothly changed when the patient lying on the cushion part 100 is changed to look left or look right in the lying state.

The locking plate 140 may prevent the patient from falling due to contraction of the cell members 110a and 110d disposed on the outmost.

That is, when the cell members 110a and 110d disposed on the outmost are contracted while the patient is lying on the cushion part 100, the heights of the cell members 110a and 110d disposed at the outside are lower than those of the cell members 110b and 110c disposed in the center, so that the patient inclines outward. At this time, as the patient inclines excessively outward, the patient with poor behavior may roll sideways and escape from the cushion part 100 and fall outside.

As the locking plates 140 are positioned in close contact with the outer surfaces of the cell members 110a and 110d disposed on the outmost, even if the heights of the outer cell members 110a and 110d are lowered than those of the center cell members 110b and 110c due to contraction of the outer cell members 110a and 110d, the locking plates 140 are provided at the boundaries of the cell members 110a to 110d to support a patient with poor behavior, thereby preventing the patient from rolling sideways and falling. The upper surface of the locking plate 140 is provided to have the same shape and height as the embossed upper surface of the cell member so as not to be locked on the locking plate 140 when the lying patient moves to the outside.

The locking plate 140 may be configured to include all or part of plastics that may have a certain rigidity, metals such as copper, aluminum, stainless steel, and iron, and alloys thereof, in order to be able to support the patient who is inclined to escape from the cushion part 100 to the outside.

In addition, the locking plate 140 may be configured in the form of a plate having a certain height, but is not limited thereto, and may be configured in the form of a rod or a net.

At least one or more air holes 150 are provided on the upper surfaces of the cell members 110a to 110d at regular intervals, and in some cases, natural or warm air may be selectively introduced and sprayed continuously or intermittently according to a temperature.

Since the air is evenly sprayed through the air holes 150 on the entire upper surface of the cushion part 100, even if the patient's skin is in close contact with the surface, the air sprayed through the spray pressure and the embossed surface circulates while being in direct contact on the skin, so that the patient's skin and sweat are removed to prevent bacterial growth, thereby preventing bedsores.

The frame member 200 is provided with a storage space for storing the cushion part 100 having an open top surface, a bottom surface and side surfaces surrounding the bottom surface and serves to support the movement according to a width change to be fixed by expansion and contraction of the cushion part 100 stored in the storage space. The frame member 200 may include first fastening portions (not illustrated) for fixing the locking plate 140 of the cushion part 100 to both side surfaces of the side surface, and a seating end portion 210 for storing a coupling end portion 130 passing through the other side surface of the side surfaces and stored with a plurality of ducts 120a to 120d.

At this time, the seating end portion 210 may include a locking portion 211 that engages with a locking protrusion 131 provided on the outer circumferential surface of the coupling end portion 130 stored on the inner circumferential surface.

The control part 300 controls the opening/closing time of air input/output valves (not illustrated) by an electronic control method by setting target air pressure by time for each of the cell member 110a to 110d of the cushion part 100 to control the cell members 110a to 110d, respectively. At this time, the control part 300 may set and control the operation of each of the cell members 110a to 110d by manipulation of a caregiver.

The control part 300 may include an air generator 310 for supplying air pressure to the plurality of ducts 120a to 120d, a direction controller 320 including a solenoid valve and switching the direction in which air pressure is provided to the plurality of ducts 120a to 120d by a control signal, and a controller that generates a control signal for controlling air pressure to be sequentially supplied to the plurality of ducts 120a to 120d from left to right or from right to left with a certain time difference.

An operation of the air mat for preventing bedsores according to the present invention configured above will be described below in detail with reference to the accompanying drawings. Like reference numerals in FIG. 1 or 2 denote the same members performing the same function.

FIG. 3 is a configuration diagram for explaining the operation of the air mat for preventing bedsores according to the present invention, in a state in which all cell members are expanded.

As illustrated in FIG. 3, when the caregiver operates the air mat for preventing bedsores by manipulating the control part 300, the air pressure generated by the air generator 310 passes through the plurality of ducts 120a to 120d to each of the cell members 110a to 110d to perform expansion and contraction actions.

At this time, each of the cell members 110a to 110d is provided to be connected to the plurality of ducts 120a to 120d, respectively, to expand and contract independently, and expand or contract sequentially.

Such a configuration is applied to smoothly change a position of the patient when the patient lying on the cushion part 100 is changed to look left or look right in the lying state.

As an example, first, as illustrated in FIG. 3, when the patient is lying on the upper center of the cushion part 100, the first cell member 110a to the second cell member 110b are sequentially contracted, so that the position of the patient may be changed to look to the left.

That is, as the first cell member 110a and the second cell member 110b contract and go down, and the third cell member 110c and the fourth cell member 110d expand and go up, the patient's left shoulder goes down and the patient's right shoulder goes up, so that the patient may be changed to be naturally look to the left.

Next, by sequentially expanding the contracted first cell member 110a from the contracted second cell member 110b, all the cell members 110a to 110d maintain the expanded state while maintaining the state in which the patient faces the left direction.

Next, when the patient is lying on the left side of the cushion part 100 in the left direction, the first cell member 110a is contracted first to bring the patient's back into close contact with the adjacent second cell member 110b. That is, as the first cell member 110a contracts and goes down, and the second cell member 110b expands and goes up, the patient's back may naturally come into close contact with the second cell member 110b.

At this time, the degree of contraction of the first cell member 110a is controlled to only 50%. This is because if the first cell member 110a is contracted too much, the patient's body may turn to the left instead of the right.

Then, by contracting the second cell member 110b in close contact with the patient's back, the patient is changed to the right direction, that is, to the upward direction. At this time, the degree of contraction of the second cell member 110b is only 50%, so that the second cell member 110b is maintained the same height as the height of the first cell member 110a, which is currently contracted by only 50%.

Next, by fully expanding the first cell member 110a and the second cell member 110b by the rest of 50%, all the cell members 110a to 110d maintain the expanded state while maintaining the state in which the patient faces the left direction.

Next, when the patient is lying on the upper center of the cushion part 100, the fourth cell member 110d to the third cell member 110c are sequentially contracted, so that the position of the patient may be changed to look to the right.

That is, as the fourth cell member 110d and the third cell member 110c contract and go down, and the first cell member 110a and the second cell member 110b expand and go up, the patient's right shoulder goes down and the patient's left shoulder goes up, so that the patient may be changed to be naturally look to the right.

Next, by sequentially expanding the contracted fourth cell member 110d from the contracted third cell member 110c, all the cell members 110a to 110d maintain the expanded state while maintaining the state in which the patient faces the right direction.

Through such an operation, the caregiver may smoothly change the position of the patient when changing the patient to look to the left or to look to the right in a lying state.

In addition, at least one or more air holes 150 are provided on one side of each of the cell member 110a to 110d, and preferably, the air holes 150 are installed in a region in contact with the patient's body. At this time, since the air inside the cell members is discharged through the air holes 150, moisture due to sweat from the patient's body is dried by the wind coming out of the air holes 150, thereby reducing the possibility of bedsores.

On the other hand, all documents, including unexamined documents, patent applications, patents, and the like cited in the disclosed embodiment, may be merged into the disclosed embodiment in the same way as each cited document is individually and specifically merged and shown or merged as a whole in the disclosed embodiment.

In order to understand the disclosed embodiment, a reference numeral is described in the preferred embodiments shown in the drawing, and specific terms are used to describe the disclosed embodiments, but the embodiments disclosed by the specific term are not limited, and the disclosed embodiments may include all components that can be ordinarily conceived by those skilled in the art.

Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential”, “important”, etc., the connections may not be components particularly required for application of the disclosed embodiment.

In addition, those skilled in the art of the present invention will be able to understand that various embodiments are possible within the scope of the technical ideas of the present invention. Accordingly, the true technical scope of the present invention should be defined by the technical spirit of the appended claims.

### INDUSTRIAL APPLICABILITY

The present invention relates to an air mat for preventing a bedsore, and has an industrial applicability.

1. A air mat for preventing bedsores comprising: a cushion part 100 in which at least two or more cell members 110a to 110d are disposed in a row direction, and each of the cell members 110a to 110d has an independent inner space, and is connected with ducts 120a to 120d for supplying air pressure for each cell member to receive air pressure independently, so that expansion and contraction can be performed;
a frame member 200 provided with a storage space having an open top surface, a bottom surface and side surfaces surrounding the bottom surface; and
a control part 300 that controls the opening/closing time of air input/output valves by an electronic control method by setting target air pressure by time for each of the cell member 110a to 110d of the cushion part 100 to control the cell members 110a to 110d, respectively,
wherein at least two of the cell members 110a to 110d sequentially expand and contract from left to right or from right to left with a certain time difference.

2. The air mat for preventing bedsores of claim 1, wherein
the cushion part 100 comprises
cell members 110a to 110d which have independent inner spaces, have at least two or more of which are arranged in a row direction, and expand and contract sequentially in one directions A and B with a certain time difference by pneumatic pressure;
a locking plate 140 provided to have a constant height and closely positioned to the outer surfaces of the cell members 110a and 110d disposed on the outmost among the cell members 110a to 110d to prevent a patient from falling; and
at least one air hole 150 for spraying air introduced through ducts 120a to 120d to the upper surfaces of the cell members 110a to 110d.

3. The air mat for preventing bedsores of claim 1, wherein
the control part 300 comprises
an air generator 310 for supplying air pressure to the plurality of ducts 120a to 120d;
a direction controller 320 including a solenoid valve and switching the direction in which air pressure is provided to the plurality of ducts 120a to 120d by a control signal; and
a controller that generates a control signal for controlling air pressure to be sequentially supplied to the plurality of ducts 120a to 120d from left to right or from right to left with a certain time difference.
